(19) United States
(12) Patent Application Publication
(10) Pub. No.: US 2025/0303995 A1
(43) Pub. Date: Oct. 2, 2025

(54) OCCUPANT PROTECTION DEVICE

(71) Applicant: TOYODA GOSEI CO., LTD., Kiyosu-shi (JP)

(72) Inventor: Shota WATANABE, Kiyosu-shi (JP)

(21) Appl. No.: 19/065,539

(22) Filed: Feb. 27, 2025

(30) Foreign Application Priority Data
Mar. 28, 2024 (JP) 2024-054002

(51) Int. Cl. B60R 21/206; B60R 21/2155; B60R 21/2338

(52) U.S. Cl. CPC B60R 21/206; B60R 21/2155; B60R 21/2338; B60R 2021/23388

(57) ABSTRACT

An occupant protection device includes a grab box attached to an instrument panel in front of a passenger seat, and an airbag device installed in the grab box. The grab box includes a box body and a lid portion that is movable rearward. The lid portion is moved rearward by a pressing force from the airbag when the bag is deployed. A bulging opening that inflates the airbag upward is formable between a rear wall portion of the instrument panel and the lid portion. The deployed airbag is supported by the lid portion that has moved rearward, the instrument panel located in front of the lid portion, and a windshield located above the instrument panel.

### BACKGROUND

### 1. Technical Field

The present invention relates to an occupant protection device for protecting an occupant seated on a passenger seat of a vehicle.

### 2. Description of Related Art

For example, in a passenger seat occupant protection device described in JP 2014-69730 A, an airbag device is installed in an instrument panel in front of a passenger seat, and an airbag door formed in an upper wall portion of the instrument panel is deployed, whereby an upper body of a passenger is protected by the airbag inflated upward from an opening formed in the upper wall portion.

However, in the configuration of the occupant protection device as described above, there is a problem that the degree of freedom of design in the upper portion of the instrument panel is limited due to the installation of the airbag device.

### SUMMARY

An object of the present invention is to provide an occupant protection device capable of protecting an occupant in a passenger seat by an airbag without impairing a degree of freedom of design in an upper portion of an instrument panel.

The present invention relates to an occupant protection device having the following configuration.

An occupant protection device includes
a grab box attached to an instrument panel in front of a passenger seat and having a box body and a lid portion, and
an airbag device that is installed in the grab box and supplies an inflation gas to an airbag to deploy the airbag rearward, wherein
the grab box includes an inner member and an outer member movable rearward with respect to the inner member, the outer member moves rearward by a pressing force from the airbag when the bag is deployed, and a bulging opening that inflates the airbag upward is formable between a rear wall portion of the instrument panel and the outer member, and wherein
the deployed airbag is supported by the outer member that has moved rearward, the instrument panel located in front of the outer member, and a windshield located above the instrument panel.

According to the occupant protection device having the above configuration, since the airbag accommodated in the grab box is inflated from the opening formed between the rear wall portion of the instrument panel and the outer member of the grab box, it is not necessary to provide the opening for inflating the airbag in the upper wall portion of the instrument panel. Therefore, it is possible to avoid impairment of the degree of freedom of design in the upper portion of the instrument panel due to installation of the airbag device.

In addition, the airbag inflated and deployed from the inside of the grab box is supported at three locations of the outer member that has moved rearward, the instrument panel located in front of the outer member, and the windshield located above the instrument panel, and a desired deployed shape can be obtained.

In the occupant protection device having the above configuration, the outer member may include the lid portion, and the upper end of the lid portion may be an engagement support portion that supports the deployed airbag. In this case, the airbag may have an engagement recess that is opened downward and engages with the engagement support portion.

Further, in the occupant protection device having the above configuration, a front inflation portion that covers an upper face of the instrument panel when deployment is completed can be provided in the airbag.

Further, in the occupant protection device having the above configuration, an upper face of the instrument panel that is allowed to come into contact with the airbag may be an inclined face that is directed upward as it goes frontward.

In the occupant protection device having the above configuration, an inclined wall portion that is inclined rearward as it goes upward may be provided at a position, of the lid portion, facing the airbag installed in the grab box.

### BRIEF DESCRIPTION OF THE DRAWINGS

FIG. 1 is a schematic longitudinal sectional view illustrating a state in which an occupant protection device according to an embodiment of the present invention is mounted on a vehicle;

FIG. 2 is a front view of a grab box in a state where a window portion is closed;

FIG. 3 is an enlarged view of the grab box in FIG. 1;

FIG. 4A is an explanatory view of a movement mechanism in the grab box, illustrating a state in which a lid portion is brought close to the grab box, and FIG. 4B is an explanatory view of the movement mechanism in the grab box, illustrating a state in which the lid portion is detached from the grab box;

FIG. 5 is an explanatory view of the movement mechanism in the grab box taken along line V-V in FIG. 4A;

FIG. 6 is a schematic longitudinal sectional view illustrating a state in which the airbag used in the occupant protection device of the embodiment is inflated alone;

FIG. 7 is a plan view illustrating a base fabric constituting the airbag of FIG. 6;

FIG. 8 is a schematic longitudinal sectional view of a state where the airbag completes inflation in the occupant protection device according to the embodiment; and

FIGS. 9A, 9B and 9C are diagrams of a modification in which an opening and closing mechanism of the grab box is different.

### DESCRIPTION OF THE PREFERRED EMBODIMENTS

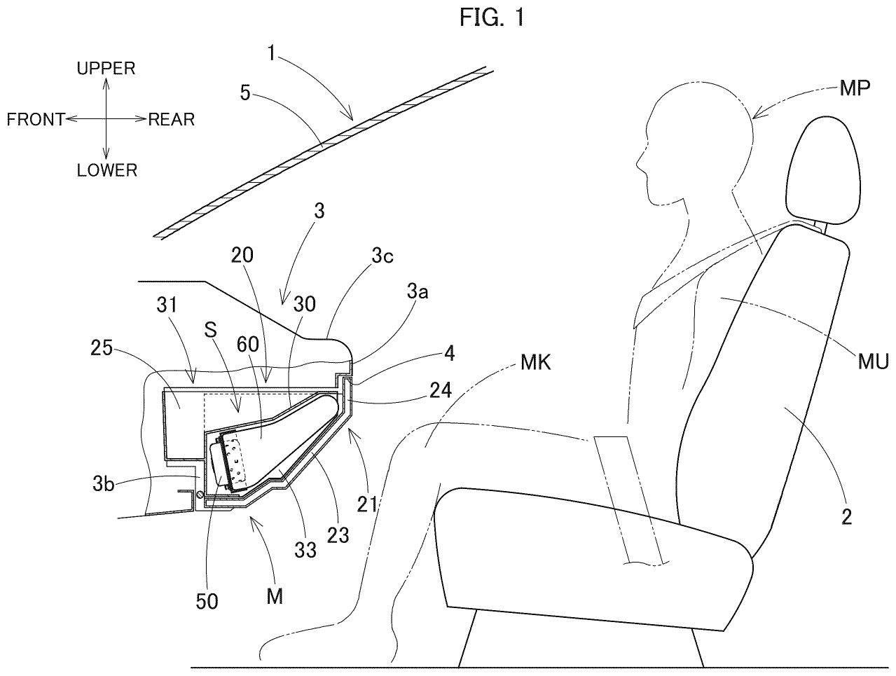

Hereinafter, an embodiment of the present invention will be described with reference to the drawings. FIG. 1 is a schematic longitudinal sectional view illustrating a state in which an occupant protection device according to an embodiment of the present invention is mounted on a vehicle. In the present embodiment, the front-rear, up-down, and left-right directions coincide with the front-rear, up-down, and left-right directions of a vehicle 1 unless otherwise specified. In the drawing, an instrument panel 3 is disposed in front of a passenger seat 2 in the interior of the vehicle 1, and a windshield 5 inclined upward as it goes to the rear of the vehicle is disposed above the instrument panel 3.

A grab box 20 is attached to the instrument panel 3 at a position in front of the passenger seat 2. An occupant protection device M of the present embodiment includes the grab box 20 and an airbag device S installed in the grab box 20.

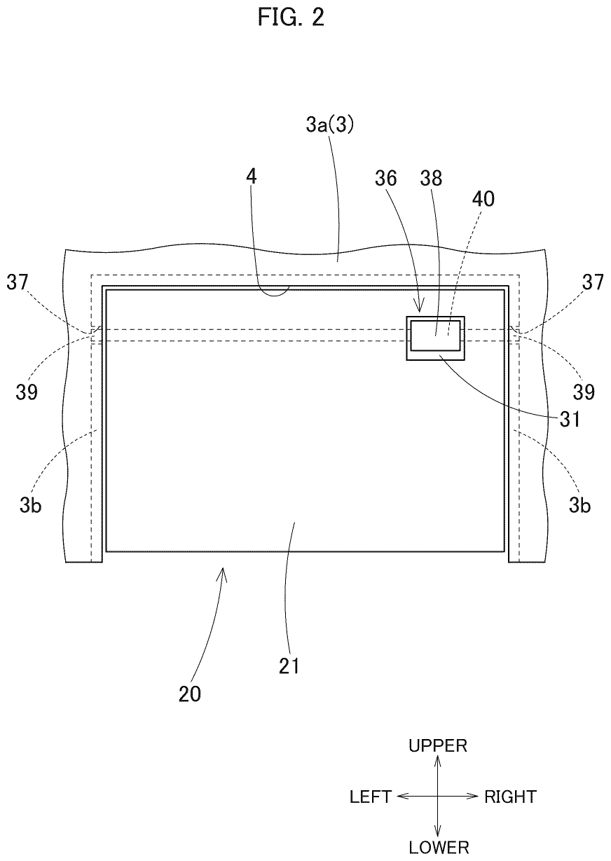

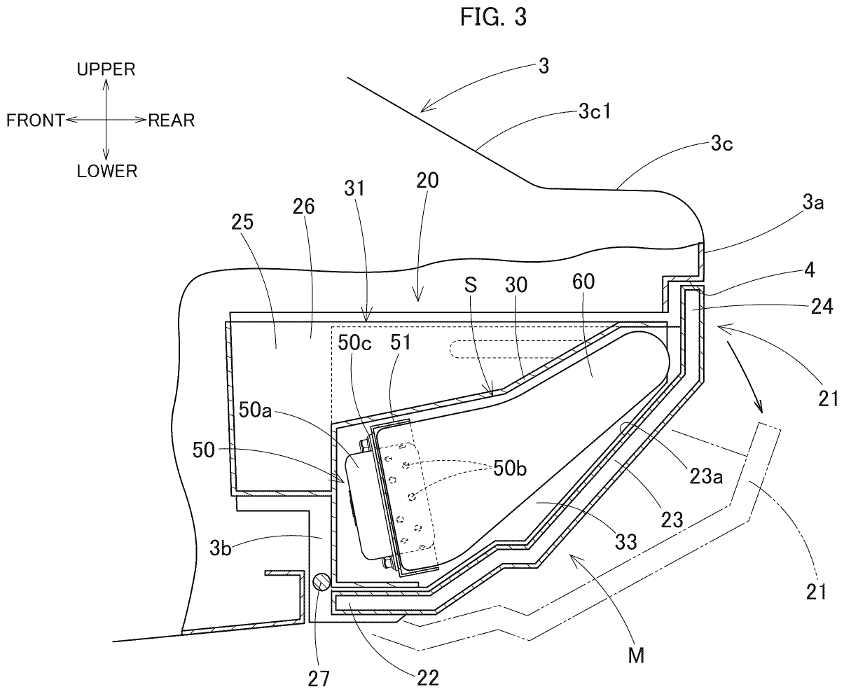

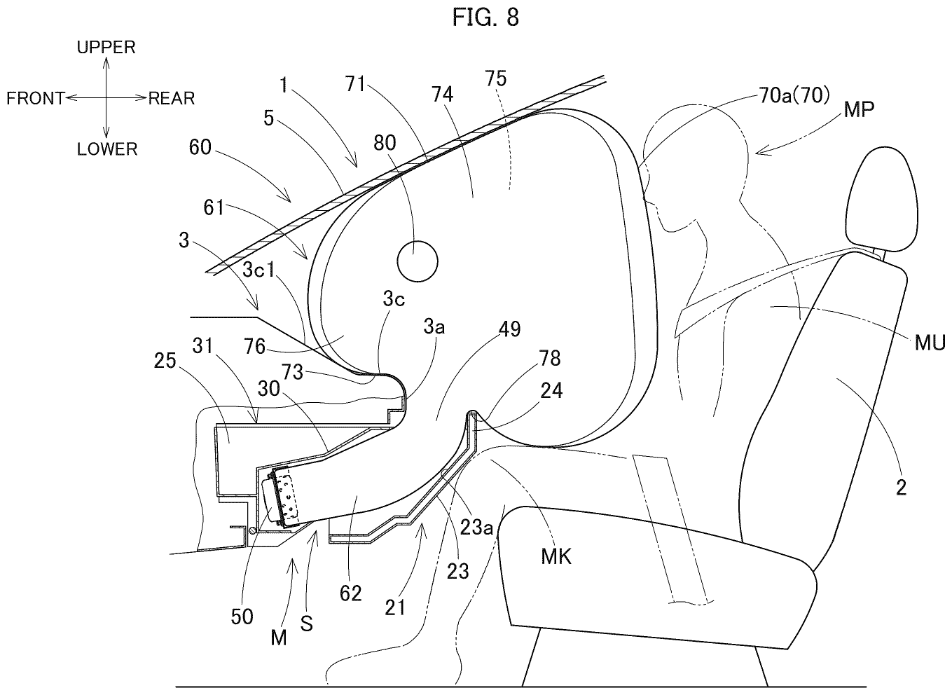

The grab box 20 includes a lid portion 21 and a box body 31. As illustrated in FIG. 2, the instrument panel 3 in front of the passenger seat has a pair of side walls 3b extending forward in a state of being separated in the vehicle left-right direction. A window portion 4 is formed between the pair of side wall portions 3b and at a rear wall portion 3a of the instrument panel 3. The lid portion 21 of the grab box 20 opens and closes the window portion 4. As illustrated in FIG. 3 and the like, the lid portion 21 has an inclined wall portion 23 that is inclined rearward as it goes upward following a bottom portion 22 extending in the horizontal direction, and further has an upper end 24 that is extended upward in the vertical direction following the inclined wall portion 23. The upper end 24 is an engagement support portion that supports the deployed bag body 61 from below (see FIG. 8).

The box body 31 includes a small article accommodation portion 25 and an airbag accommodation portion 33, which are integrally formed. The small article accommodation portion 25 is a portion for storing small articles and the like provided in front of the lid portion 21, and an open portion at an upper end thereof constitutes an entrance 26 of a stored object.

An open portion on the rear end side of the small article accommodation portion 25 is closed by a partition wall 30, and the airbag accommodation portion 33 is provided on the vehicle rear side of the box body 31 partitioned from the small article accommodation portion 25 by the partition wall 30. The airbag accommodation portion 33 is opened at the rear end, and the airbag device S is installed in the airbag accommodation portion 33 such that the rear side portion thereof faces the lid portion 21.

A shaft 27 supported by the side wall 3b of the instrument panel 3 and extending in the vehicle left-right direction is provided at the lower part of the grab box 20, and the grab box 20 including the lid portion 21 and the box body 31 is configured to be rotatable around the shaft 27 as indicated by a two-dot chain line in FIG. 3.

As illustrated in FIG. 2, a coupling mechanism 36 for releasably coupling the box body 31 to the instrument panel 3 is provided between the box body 31 and the instrument panel 3. The coupling mechanism 36 includes a pair of engagement holes 37, an operation handle 38, a pair of lock pins 39, and a transmission mechanism 40.

Each engagement hole portion 37 penetrates both the side wall portions 3b of the instrument panel 3 in the left-right direction. The operation handle 38 is disposed in a recess which is at a rear upper portion of the lid portion 21 and whose rear end is opened, and the operation handle 38 is supported so as to be rotatable in the up-down direction with respect to the box body 31. The pair of lock pins 39 is supported by the box body 31 so as to be movable in the left-right direction.

Although a specific configuration of the transmission mechanism 40 is omitted, the transmission mechanism 40 has a function of converting rotation of the operation handle 38 in the up-down direction into linear motion in the horizontal direction and in directions opposite to each other and transmitting the linear motion to both the lock pins 39. When the operation handle 38 is not rotationally operated, the transmission mechanism 40 causes each lock pin 39 to protrude outward from the box body 31 and engage with the corresponding engagement hole 37. With this engagement, the box body 31 is connected to the instrument panel 3, and the rotation of the box body 31 about the shaft 27 is restricted.

When the operation handle 38 is rotated upward, the transmission mechanism 40 moves each lock pin 39 inward and retreats from the engagement hole 37 to release the connection of the box body 31 to the instrument panel 3. Accordingly, the box body 31 can be rotated about the shaft 27 between the closed position and the open position.

Between the box body 31 and the lid portion 21, there is provided a movement mechanism portion 42 that allows the lid portion 21 to slide in the approaching and separating direction. The movement mechanism portion 42 includes a guide groove 44 and a pin 47 that engage with each other.

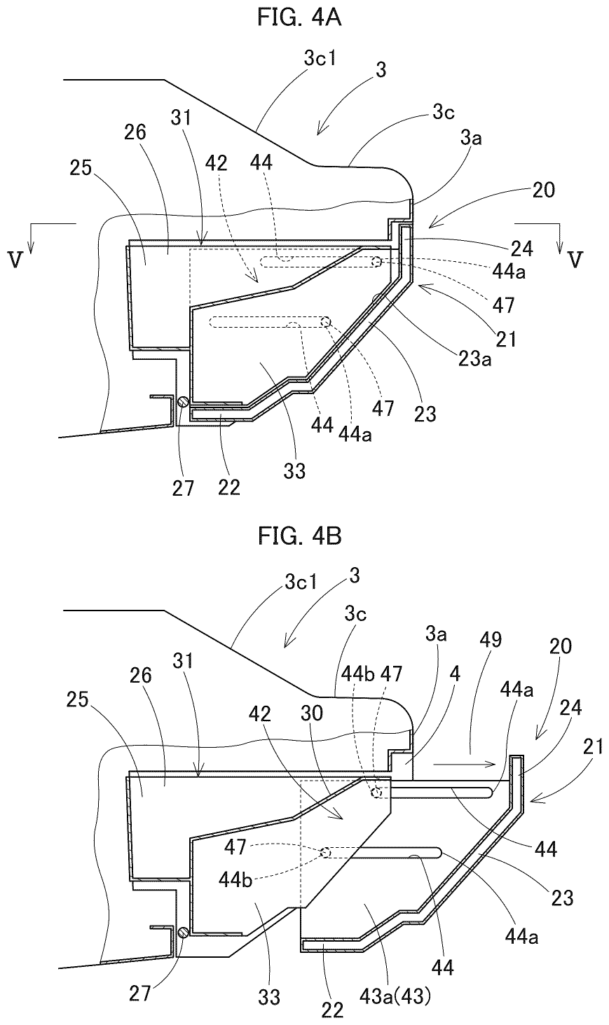

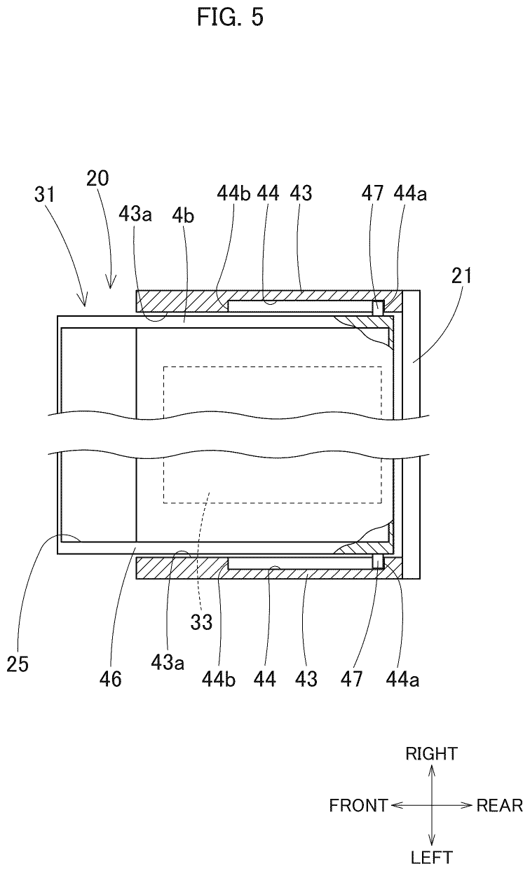

As illustrated in FIGS. 4B and 5, guide plates 43 extending in the front-rear direction are connected to both ends of the lid portion 21 in the left-right direction. At the inner face 43a of each guide plate 43, a plurality of (two separated in the up-down direction in this example) guide grooves 44 is formed so as to extend in the horizontal direction.

On the other hand, a pair of left and right side wall portions 46 of the box body 31 is provided with a plurality of pins 47 protruding outward in the left-right direction and engaging with the guide grooves 44.

In a proximity state where the lid portion 21 is in proximity to the box body 31 (see FIG. 4A), the guide grooves 44 are engaged with the pins 47 at rear ends 44a, and the position of the lid portion 21 in the proximity state is defined. Although not illustrated, in the present embodiment, a holding mechanism for holding the lid portion 21 in the proximity state is provided.

On the other hand, in a detachment state where the lid portion 21 is separated from the box body 31 by a predetermined distance (see FIG. 4B), the guide grooves 44 are engaged with the pins 47 at front ends 44b, and the position of the lid portion 21 in the detachment state is defined.

Here, the movement of the lid portion 21 from the proximity state to the detachment state is executed by the lid portion 21 receiving pressure when an airbag 60 is deployed and inflated. In the present embodiment, it is also possible to separately provide a lock mechanism for holding the lid portion 21 at a predetermined detachment state position.

In the occupant protection device M of the present embodiment configured as described above, the box body 31 constitutes the inner member of the present invention, and the lid portion 21 constitutes the outer member movable rearward with respect to the inner member (the box body 31).

Next, the airbag device S installed in the airbag accommodation portion 33 will be described. As illustrated in FIG. 3, the airbag device S includes the airbag 60 folded and covered with a wrapping member, an inflator 50 that supplies an inflation gas to the airbag 60, a case 51 as a storage portion that stores and holds the airbag 60 and the inflator 50, and the like.

The inflator 50 includes a substantially columnar body 50a having a plurality of gas discharge ports 50b, and a flange 50c for attaching the inflator 50 to the case 51.

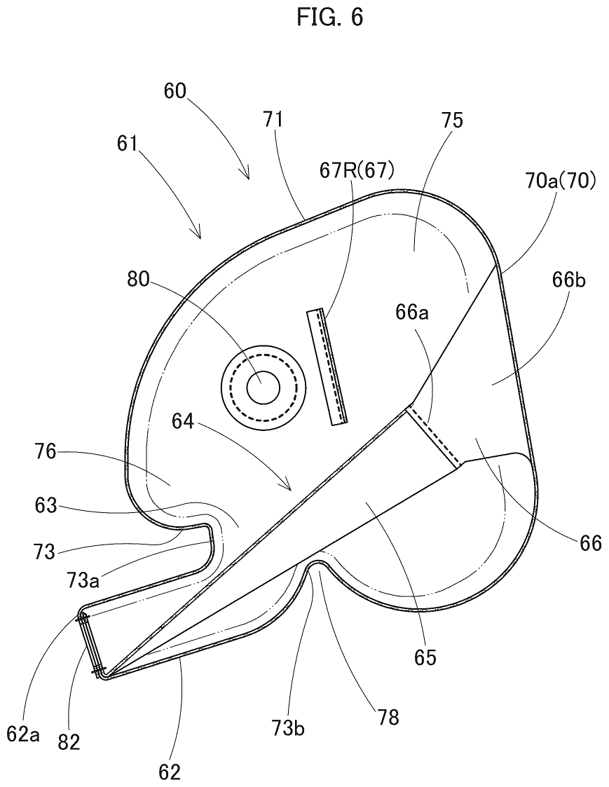

The case 51 is formed in a three-dimensional shape made of sheet metal having an opening at the upper end, and the peripheral edge of an inflow opening 82 (see FIG. 6) in the airbag 60 and the flange 50c of the inflator 50 are attached to the bottom wall portion of the case 51. A bracket (not illustrated) connected to the box body 31 of the grab box 20 is disposed on the bottom wall portion of the case 51.

As illustrated in FIGS. 6 to 8, the airbag 60 includes a bag body 61, a conduit portion 62 that allows an inflation gas to flow into the bag body 61, and tethers 64 and 67 that are disposed in the bag body 61 and regulate an inflation-completed shape of the bag body 61.

As illustrated in FIG. 6, the bag body 61 has a substantially triangular prism shape in which the axial direction is substantially along the left-right direction as an outer shape at the time of completion of inflation, and includes an occupant side wall portion 70 that is disposed on an occupant MP side at the time of completion of inflation and receives the occupant MP, a front upper wall portion 71 that is disposed in front of and away from the occupant MP at the time of completion of inflation and comes into contact with the windshield 5, a lower wall portion 73 that is located below the front upper wall portion 71 at the time of completion of inflation, and a left wall portion 74 and a right wall portion 75 that are disposed to face each other in the left-right direction at the time of completion of inflation.

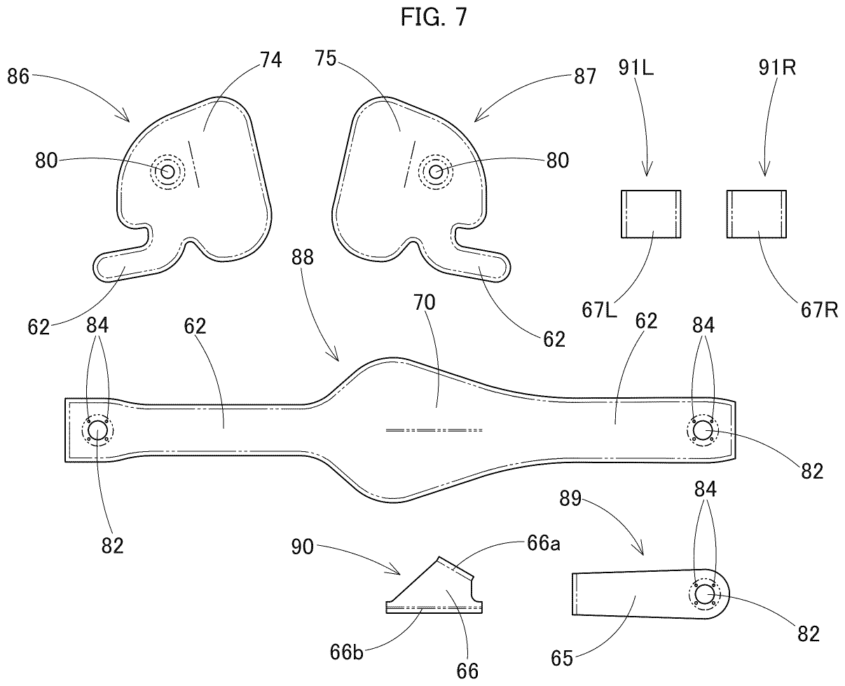

The conduit portion 62 is formed at a substantially central position of the lower wall portion 73 in the front-rear direction so as to extend obliquely leftward and downward in the drawing. Upon completion of inflation, the conduit portion 62 is mostly disposed in the grab box 20 (see FIG. 8). The inflow opening 82 having the peripheral edge attached to the bottom wall portion of the case 51 is formed at a distal end of the conduit portion 62. A plurality of (in the case of the present embodiment, four) attachment holes 84 (see FIG. 7) for attaching the peripheral edge of the inflow opening 82 to the bottom wall portion of the case 51 by inserting attachment bolts (not illustrated) is formed at the peripheral edge of the inflow opening 82.

In the bag body 61, a front inflation portion 76 that covers an upper face 3c of the instrument panel 3 when the deployment is completed is formed from a front side 73a of the connection portion between the lower wall portion 73 and the conduit portion 62 in front of the lower wall portion 73.

An engagement recess 78 opened downward is formed in a portion from a rear side 73b of the connection portion between the lower wall portion 73 and the conduit portion 62 to the rear side of the lower wall portion 73. The engagement recess 78 is formed at a position corresponding to the upper end (engagement support portion) 24 of the lid portion 21 in the detachment state in which the lid portion slides rearward.

In the left wall portion 74 and the right wall portion 75 of the bag body 61, a vent hole 80 for discharging an excessive inflation gas flowing into the bag body 61 via the conduit portion 62 is formed to open in a substantially circular shape.

As the tethers that regulate the inflation completed shape of the bag body 61, the front-rear tether 64 and the left and right tethers 67 are disposed inside the bag body 61.

The front-rear tether 64 connects substantially the center of the occupant side wall portion 70 in the left-right direction and the front end 62a of the conduit portion 62 so as to be substantially along the front-rear direction, and, in the present embodiment, is configured so as to connect a front portion 65 extending from the peripheral edge of the inflow opening 82 and a rear portion 66 extending from the occupant side wall portion 70 (see FIG. 6). In the case of the present embodiment, the front portion 65 is formed by folding a band-shaped front portion material 89 illustrated in FIG. 7, and has a three-dimensional shape approximating a substantially triangular pyramid shape in which the front end is substantially along the left-right direction and the rear end is substantially along the up-down direction as an outer shape when the inflation of the bag body 61 is completed. The rear portion 66 is configured as a substantially trapezoidal shape having an outer shape narrowed toward the front end 66a connected to the front portion 65. In the case of the present embodiment, the rear portion 66 has a rear edge 66b connected to a position of the occupant side wall portion 70, the position being substantially at the center in the up-down direction (see FIG. 6). The front-rear tether 64 is disposed to suppress excessive protrusion of the airbag 60 rearward when the airbag 60 is deployed and inflated, and to regulate a separation distance of the occupant side wall portion 70 from the front end 62a when the airbag 60 is completely inflated.

The left and right tethers 67 are configured such that the pair of left and right tether bodies 67L and 67R is disposed substantially along the left and right direction so as to connect the left wall portion 74 and the right wall portion 75 facing each other in the left and right direction in the bag body 61, and protrusion of the left wall portion 74 and the right wall portion 75 outward in the left and right directions is suppressed.

The airbag 60 is formed in a bag shape by joining peripheral edges of the base fabric having a predetermined shape. In the case of the present embodiment, as illustrated in FIG. 7, the airbag includes an outer left panel 86 and an outer right panel 87 which are disposed outward in the left-right direction when inflation is completed, a peripheral wall panel 88 which is disposed between the outer left panel 86 and the outer right panel 87 and mainly constitutes the occupant side wall portion 70, a front portion material 89 and a rear portion material 90 which constitute the front-rear tether, and tether materials 91L and 91R which constitute the left and right tethers 67.

The outer left panel 86, the outer right panel 87, the peripheral wall panel 88, the front portion material 89, the rear portion material 90, and the tether materials 91L and 91R are each formed of a flexible woven fabric made of a polyester yarn, a polyamide yarn, or the like.

Next, a series of operations in the occupant protection device M of the present embodiment will be described. In the occupant protection device M of the present embodiment, when the inflator 50 operates while the grab box 20 is fixed to the instrument panel 3 at the closed position where the grab box closes the window portion 4 of the instrument panel 3, the airbag 60 installed in the airbag accommodation portion 33 starts to be deployed and inflated by the inflation gas discharged from the inflator 50. At this time, the lid portion 21 moves rearward to a predetermined position (a position where the guide grooves 44 engage with the pins 47 at the front end 44b) by receiving pressure when the airbag 60 is deployed and inflated, and as illustrated in FIG. 4B, an opening (bulging opening) 49 for bulging the airbag 60 upward is formed between the rear wall portion 3a of the instrument panel 3 and the lid portion 21.

In addition, the lid portion 21 that has moved rearward includes the inclined wall portion 23 in the inclined state substantially similar to that of a knee MK of the occupant MP, and as illustrated in FIG. 8, the lid portion 21 is close to the knee MK of the occupant MP to suppress the forward movement of the knee MK.

The airbag 60 that has started to be deployed in the grab box 20 is guided upward along an inner face 23a of the inclined wall portion 23 and exits upward from the grab box 20 through the opening 49. Then, the bag body 61 of the airbag 60 is deployed in the upward and rearward direction and inflates in the upward and rearward direction up to the limit defined by the front-rear tether 64, and then also inflates in the downward and forward direction. At this time, the front side of the lower wall portion 73 of the bag body 61 (specifically, a portion from the connection portion front side 73a to the front inflation portion 76) is supported by the rear wall portion 3a and the upper face 3c of the instrument panel 3, the rear side of the lower wall portion 73 (specifically, the engagement recess 78) is supported by the upper end 24 of the lid portion 21, the front upper wall portion 71 of the bag body 61 is supported by the windshield 5, and when the inflation is completed, the bag body 61 is disposed in front of an upper body MU of the occupant MP in a desired deployed shape.

Therefore, even in a case where the upper body MU of the occupant MP greatly moves forward when the airbag 60 (bag body 61) is completely inflated, since the lower wall portion 73 and the front upper wall portion 71 of the bag body 61 are supported by the instrument panel 3 and the windshield 5 with a wide area, falling and compression are suppressed, and the upper body MU of the occupant MP can be properly restrained by an upper body restraining face 70a disposed to face the front of the upper body MU.

According to the occupant protection device M of the present embodiment configured as described above, since the airbag 60 accommodated in the grab box 20 is inflated from the opening 49 formed between the rear wall portion 3a of the instrument panel 3 and the lid portion 21 of the grab box 20, it is not necessary to provide an opening for inflating the airbag 60 at the upper wall portion of the instrument panel 3. Therefore, it is possible to avoid impairment of the degree of freedom of design in the upper portion of the instrument panel 3 due to the installation of the airbag 60.

In addition, the airbag 60 inflated and deployed from the inside of the grab box 20 is supported at three locations of the lid portion 21 that has moved rearward, the instrument panel 3 located in front of the lid portion 21, and the windshield 5 located above the instrument panel 3, and can obtain a desired deployed shape.

According to the occupant protection device M of the present embodiment, the outer member includes the lid portion 21, the upper end 24 of the lid portion 21 is an engagement support portion that supports the deployed airbag 60, and the lid portion 21 of the grab box 20 can be effectively used as a support component of the airbag 60.

In the occupant protection device M of the present embodiment, the engagement recess 78 opened downward and engaged with the upper end 24 of the lid portion 21 is provided in the airbag 60, and the deployed airbag 60 can be supported at a desired position by the engagement between the upper end 24 and the engagement recess 78.

In the occupant protection device M of the present embodiment, the front inflation portion 76 covering the upper face 3C of the instrument panel 3 is provided in the airbag 60 when the deployment is completed, and the deployed airbag 60 is supported not only by the rear wall portion 3a of the instrument panel 3 but also by the upper face 3c of the instrument panel 3.

Further, in the occupant protection device M of the present embodiment, part of the upper face 3c of the instrument panel that is allowed to come into contact with the airbag 60 is an inclined face 3cl (see FIG. 8) that is directed upward as it goes frontward, and the airbag 60 comes into contact with the inclined face 3cd, so that it is possible to increase the reaction force when the upper body of the occupant MP is received by the airbag 60.

Further, in the occupant protection device M of the present embodiment, the inclined wall portion 23 which is inclined rearward as it goes upward is provided at a position of the lid portion 21, the position facing the airbag 60 installed in the grab box 20, and the airbag 60 which starts to be deployed in the grab box 20 can be guided upward along the inner face 23a of the inclined wall portion 23. In addition, the lid portion 21 includes the inclined wall portion 23 in an inclined state substantially similar to that of the knee MK of the occupant MP, and can effectively restrain the knee MK of the occupant MP when moving in the vehicle rear direction by receiving the pressing force from the airbag 60.

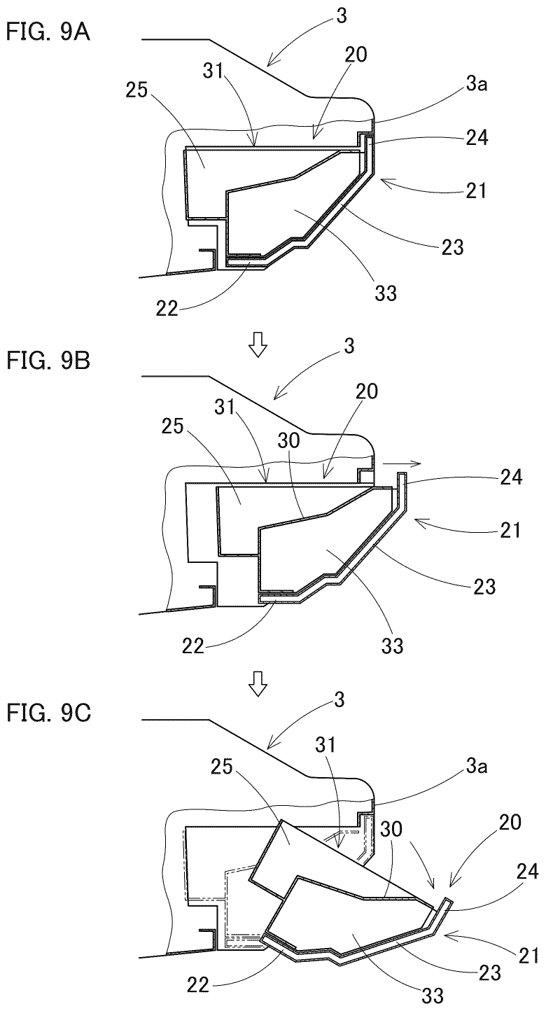

FIGS. 9A-9C are views of a modification in which an opening and closing mechanism of the grab box 20 is different. The opening and closing mechanism of the grab box 20 is not limited to the above embodiment, and can be appropriately changed.

In the example of FIGS. 9A-9C, the lid portion (outer member) 21 and the box body (inner member) 31 are integrally held in a state of being close to each other by an engagement member (not illustrated). In this example, in a case where the grab box 20 is opened by the operation by the occupant from the closed state illustrated in FIG. 9A at the normal time, as illustrated in FIG. 9B, first, the lid portion 21 and the box body 31 slide rearward, and thereafter, as illustrated in FIG. 9C, the lid portion 21 and the box body 31 rotate downward about the axis at the position after the movement, and the grab box 20 is opened.

Also in the example of FIGS. 9A-9C, in addition to the opening and closing mechanism described above, the movement mechanism portion 42 (see FIGS. 4A and 4B) that enables the lid portion 21 to slide in the approaching and separating direction is provided between the box body 31 and the lid portion 21. At the time of collision (at the time of deploying the bag), the lid portion 21 and the box body 31 are disengaged by receiving a pressing force from the airbag 60 provided in the airbag accommodation portion 33, and the lid portion 21 is detached from the box body 31 to be movable rearward from the state illustrated in FIG. 9A.

Although the embodiment and modification of the present invention have been described in detail above, these are merely examples, and the present invention can be implemented in various modified modes without departing from the gist thereof.

For example, in the above embodiment, the lid portion 21 as the outer member is horizontally moved rearward, but in some cases, the lid portion 21 may be moved obliquely downward.

In the above embodiment, the entire lid portion 21 is movable rearward, but only part of the lid portion 21 may be movable rearward.

The airbag used in the occupant protection device of the present invention is not limited to the above embodiment, and can be appropriately changed. For example, it is also possible to provide a straightening cloth inside the airbag. The straightening cloth may cover the upper side of the gas inflow opening (indicated by reference numeral 63 in FIG. 6) of the bag body and may have a substantially tubular shape with both sides opened, so that the inflation gas flowing into the bag body 61 is once divided into the front side and the rear side to flow.

What is claimed is:

1. An occupant protection device (M) comprising:
a grab box (20) attached to an instrument panel (3) in front of a passenger seat (2) and having a box body (31) and a lid portion (21); and
an airbag device (S) that is installed in the grab box (20) and supplies an inflation gas to an airbag (60) to deploy the airbag (60) rearward, wherein
the grab box (20) includes an inner member and an outer member movable rearward with respect to the inner member, the outer member moves rearward by a pressing force from the airbag (60) when the bag is deployed, and a bulging opening (49) that inflates the airbag (60) upward is formable between a rear wall portion (3a) of the instrument panel (3) and the outer member, and wherein
the deployed airbag (60) is supported by the outer member that has moved rearward, the instrument panel (3) located in front of the outer member, and a windshield (5) located above the instrument panel (3).

2. The occupant protection device (M) according to claim 1, wherein
the outer member includes the lid portion (21), and an upper end (24) of the lid portion (21) is an engagement support portion that supports the deployed airbag (60).

3. The occupant protection device (M) according to claim 2, wherein
the airbag (60) has an engagement recess (78) opened downward and engaged with the engagement support portion.

4. The occupant protection device (M) according to claim 1, wherein
the airbag (60) includes a front inflation portion (76) covering an upper face (3c) of the instrument panel (3) when the deployment is completed.

5. The occupant protection device (M) according to claim 4, wherein
an upper face (3c) of the instrument panel (3) that is allowed to come into contact with the airbag (60) is an inclined face (3cd) that extends upward as the upper face goes frontward.

6. The occupant protection device (M) according to claim 2, wherein
the lid portion (21) includes an inclined wall portion (23) that is inclined rearward as the inclined wall portion goes upward at a position facing the airbag (60) installed in the grab box (20).
